(19) United States
(12) Patent Application Publication
(10) Pub. No.: US 2002/0083202 A1
(43) Pub. Date: Jun. 27, 2002

(54) Website browsing system, portable terminal, network server, and facsimile

(75) Inventor: Noriyasu Nakamura, Shizuoka (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/026,324

(22) Filed: Dec. 24, 2001

(30) Foreign Application Priority Data
Dec. 26, 2000 (JP) 2000-395574

(51) Int. Cl. G06F 15/16

(52) U.S. Cl. 709/246; 709/218

(57) ABSTRACT

In a website browsing system image data of a website accessed from a portable terminal is converted to facsimile communication data by the portable terminal, sent to a facsimile and printed or displayed.

### BACKGROUND OF THE INVENTION

1. Field of the Invention

The present invention relates to a website browsing system in a portable terminal (personal digital assistant (PDA) or Personal Digital Cellular (PDC) device) connectable to a communication network such as the Internet.

2. Related Art

In portable terminals of the past, because of the display capacity thereof is relatively small, when accessing a website not intended for portable terminals from a portable terminal, it was not possible to display the entire website image on the screen of the portable terminal, thereby making it impossible to sufficiently view the contents thereof. Additionally, because this type of portable terminal seldom has a printing function, in order to keep the image, the only method possible was that of using a memory within the portable terminal, making it impossible to store the contents of a website exceeding the memory capacity of the portable terminal.

As noted above, a portable terminal of the past had the problems following problems.

(1) Because of a display capacity, it was not possible to sufficiently display the image of a website that was not intended for access from a portable terminal.

(2) Because of the lack of a printing function, the only method available for maintaining the contents of a website was that of using the memory of the portable terminal.

Accordingly, it is an object of the present invention to provide a system for browsing a website, which is capable of sufficient browsing of an accessed website from a portable terminal, and capable of keeping the image of a website.

### SUMMARY OF THE INVENTION

In order to achieve the above-noted objects, the present invention adopts the following basic technical constitution.

Specifically, a website browsing system according to the present invention has

a communication network,

a wireless base station connected the communication network,

a website, which makes available an image via the communication network,

a facsimile connectable to the communication network via a telephone line, and

a portable terminal, which is connectable to the communication network via the base station, and which, after completion of a connection operation with respect to the communication network in response to a user instruction, converts the image data made available from the website to data for facsimile communication, and sends the facsimile communication data via the telephone line to the facsimile.

In a website browsing system according to the present invention, image data of a website accessed from a portable terminal is sent to a facsimile. For this reason, in this website browsing system it is possible to sufficiently view a website accessed by a user from a portable terminal, and further possible to keep the image of the website.

### BRIEF DESCRIPTION OF THE DRAWINGS

FIG. 1 is a block diagram showing the configuration of a website browsing system according to a first embodiment of the present invention.

FIG. 2 is a block diagram showing the configuration of a portable terminal.

FIG. 3 is a block diagram showing the configuration of a website browsing system according to a second embodiment of the present invention.

FIG. 4 is a block diagram showing the configuration of a website browsing system according to a third embodiment of the present invention.

FIG. 5 is a block diagram showing the configuration of a service center.

FIG. 6 is a block diagram showing the configuration of a website browsing system according to a fifth embodiment of the present invention.

FIG. 7 is a block diagram showing the configuration of a facsimile.

FIG. 8 is a flowchart showing the operation of a facsimile in the case of receiving a call.

FIG. 9 is a block diagram showing the configuration of a website browsing system according to a seventh embodiment of the present invention.

### DETAILED DESCRIPTION OF THE PREFERRED EMBODIMENTS

Embodiments of a website browsing system according to the present invention are described in detail below, with reference made to relevant accompanying drawings.

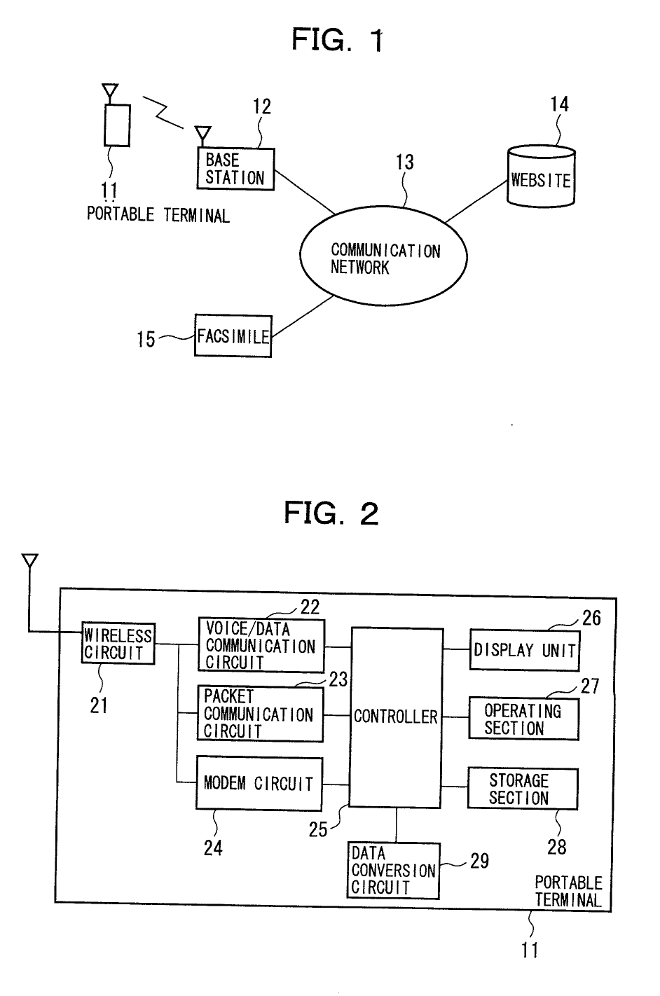

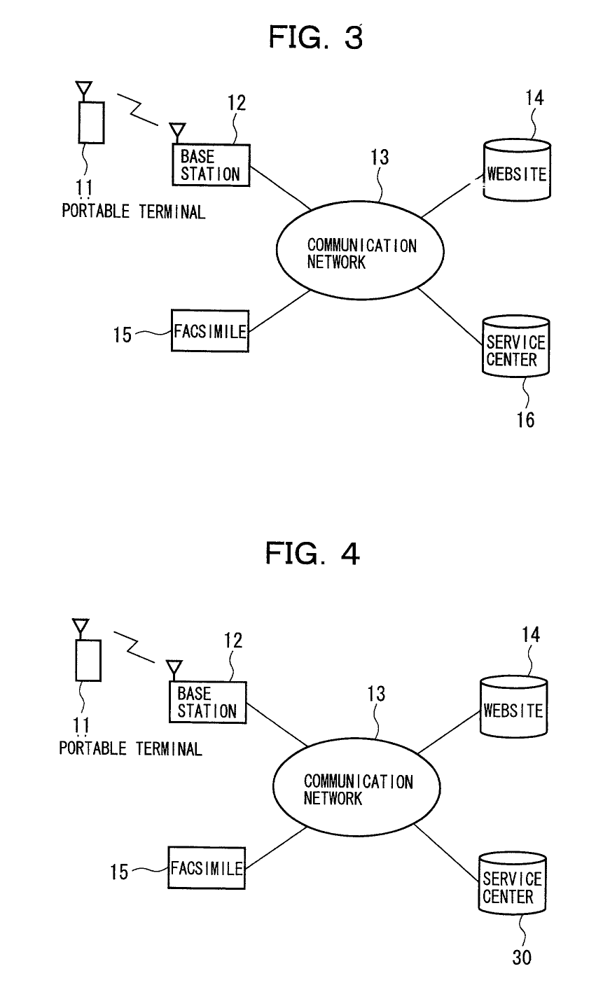

Specifically, FIG. 1 shows a website browsing system according to the first embodiment in block diagram form. As shown in FIG. 1, this embodiment of a website browsing system has a portable terminal 11, a base station 12, a communication network 13, a website 14, and a facsimile 15.

The communication network 13 is a communication network that includes a communication network such as a telephone system and the Internet, the base station 12, website 14, and facsimile 15 being connected via this communication network 13. The portable terminal 11 is a terminal that can be connected via wireless communication to the base station 12. The base station 12 is a station for connecting the portable terminal 11 to the communication network 13, and the portable terminal 11 can access a website 14 and a facsimile 15, which are connected to the communication network 13, via the base station 12. The website 14 makes image data available via the communication network 13, and the facsimile 15 can be connected via a telephone line of the communication network 13.

When the portable terminal 11 accesses the website 14, image data thereof is sent from the website 14 to the portable terminal 11, which has a function for capturing the image data. The portable terminal 11 also has a function for converting image data sent from the website 14 to facsimile communication data and sending the data to the facsimile 15. The operation of this website is described below.

First, when a user accesses a website 14 using the portable terminal 11, the portable terminal 11 captures image data from the website 14. Then, when the user specifies a menue of “facsimile transmission” selected from a hardware keyboard or from a software menu or the like such as a men-machine interface (I/F) of the potabel terminal 11, when the operation of completing a connection from the portable terminal 11 to the communication network 13 is performed, the portable terminal 11 converts the image data captured from the website 14 to facsimile communication data, and sends the facsimile communication data to the facsimile 15, via the telephone lines included in the communication network 13. The facsimile 15 at the destination, in the same manner as would a conventional facsimile, outputs the facsimile communication data thus received by printing it onto printing paper, or by displaying it on a display of the facsimile 15.

FIG. 2 is a block diagram showing the configuration of the portable terminal 11 in the website browsing system of this embodiment. The portable terminal 11 of this embodiment is made up of a wireless circuit 21, a voice/data communication circuit 22, a packet communication circuit 23, a modem circuit 24, a display unit 26, an operating section 27, a storage section 28, a data conversion circuit 29, and a controller 25.

The wireless circuit 21 is a circuit for making a wireless connection to the base station 12. The voice/data communication circuit 22 is a circuit that performs communication of voice and data via the wireless circuit 21, and in the case in which voice/data communication is being done via a telephone line in the communication network 13, this circuit operates. The packet communication circuit 23 is a circuit that performs packet communication via the wireless circuit 21, this circuit operating in the case in which communication is performed in contact with a communication network such as the Internet included in the (communication network 13). The modem circuit 24 performs facsimile communication via the wireless circuit 21, and operates in the case of sending facsimile communication data.

The display unit 26 displays a clock that indicates the time and image data sent from the website 14, this being a web page. The operating section 27 has menu keys, dialing keys and the like, and serves as a man-machine interface between the user and the portable terminal 11. The storage section 28 stores telephone numbers and the like of the facsimile 15, and image data or the like of website 14. The data conversion circuit 29 converts image data of the website 14 to facsimile communication data. The controller 25 is a control means, including a CPU or the like, which performs control of the wireless circuit 21, the voice/data communication circuit 22, the packet communication circuit 23, the modem circuit 24, the display unit 26, and operating section 27, storage section 28, and the data conversion circuit 29.

The operation of the portable terminal 11 in a website browsing system according to this embodiment of the present invention is as follows.

When the user attempts to access the website 14 by operating the operating section 27, thereby making connection to the communication network 13, the operating section 27 sends the user operation to the controller 25. The controller 25, in accordance with the user operation performed, performs control of the voice/data communication circuit 22, the packet communication circuit 23, and the wireless circuit 21, so as to make connection to the base station 12 and access the website 14 via the communication network 13.

When communication is established between the portable terminal 11 and the website 14, the portable terminal 11 receives image data of the website 14 sent via the communication network 13 and the base station 12. When the image data is received, the controller 25 performs control of the wireless circuit 21, the voice/data communication circuit 22, and or the packet communication circuit 23, stores the received image data in the storage section 28, and causes display of the image data on the display unit 26 as much as possible.

At this point, if the user selects a menue of (Facsimile Transmission) by a hardware key or software menue of the operating section 27, the controller 25 sets facsimile transmission flag to on. After that is done, with the facsimile transmission flag remaining on, when the connection completion operation with respect to the communication network 13 is performed at the operating section 27, the controller 25 sends image data stored in the storage section 28 to the data conversion circuit 29.

The data conversion circuit 29 converts the image data to facsimile communication data and sends the data to the controller 25, whereupon the controller 25 at first stores the facsimile communication data converted by the data conversion circuit 29 into the storage section 28, reads out a telephone number of the facsimile 15 that had been priorly stored in the storage section 28, and performs control of the modem circuit 24 and the wireless circuit 21 so as to read in the telephone number of the facsimile 15 and call the facsimile 15.

When communication is established between the portable terminal 11 and the facsimile 15, the controller 25 reads the facsimile communication data from the storage section 28, and performs control of the modem circuit 24 and the wireless circuit 21 so as to send the data to the facsimile 15. The telephone number of the facsimile 15 can be stored by the user beforehand in the storage section 28, and can alternatively be input by operation of the operating section 27 after completion of the connection to the communication network 13.

As described above, in a website browsing system according to this embodiment, an image of the website 14 accessed from the portable terminal 11 is sent to the facsimile 15 and printed out or displayed. For this reason, with this website browsing system, it is possible to achieve sufficient viewing of images from the website 14 accessed from the portable terminal 11 by the user, and it is possible to keep the images of the website 14.

In a second embodiment of a website browsing system according to the present invention, there is the addition of a service center 16, which is not present in the first embodiment. The service center 16 is a network server connected to the communication network 13. In the website browsing system according to this embodiment, the portable terminal 11 does not send facsimile communication data directly to the facsimile 15, but rather send the facsimile communication data to the service center 16. The service center 16 sends the image data sent from the portable terminal 11 via the telephone line of the communication network 13 to the facsimile 15. By doing this, in this website browsing system even if the portable terminal 11 remains connected to a communication network 13 such as the Internet, it is possible to use the service center 16 to send image data of the website 14 to the facsimile 15. The operation of the website browsing system of the second embodiment is as follows.

After the portable terminal 11 accesses the website 14 and captures image data of the website 14 into the storage section 28, when the user selects “Facsimile Transmission” of image data stored in the storage section 28 by a hardware key or software key, the controller 25 of the portable terminal 11 shown in FIG. 2 accesses the service center 16 using packet communication, while the connection to the Internet of the communication network 13 is maintained.

When communication is established between the portable terminal 11 and the service center 16, the controller 25 sends image data of the website 14 read from the storage section 28 to the data conversion circuit 29. The data conversion circuit 29 converts the image data of the website 14 to facsimile communication data and sends the converted data to the controller 25, whereupon the controller 25 at first stores the received converted facsimile communication data in the storage section 28, reads a telephone number of the facsimile 15 priory stored in the storage section 28, and then sends the telephone number of the facsimile 15 and the facsimile communication data stored in storage section 28 to the service center 16.

The service center 16, in accordance with the telephone number received from the portable terminal 11, makes a connection to the facsimile 15 via a telephone line of the communication network 13, sends the facsimile communication data received from the portable terminal 11, and notifies the portable terminal 11 of the result of the transmission.

The service center 16 can be established within the system of the PDA (personal digital assistant) or PDC (Personal Digital Cellular) device) and operated by automatic control, and can alternatively be installed at the website, so as to make connection to the facsimile 15 in accordance with a telephone number of the facsimile 15 input from the portable terminal 11.

The third embodiment of a website browsing system according to the present invention is shown in the block diagram of FIG. 4. In this website browsing system, there is a service center 30 in place of the service center 16 of the second embodiment.

Whereas in website browsing systems of the first and second embodiments, as shown in FIG. 2, there image data of the website 11 is converted to facsimile communication data by a data conversion circuit internal to the portable terminal 11, in a website browsing system according the third embodiment, the service center 30 has within it a data conversion circuit. The operation of this website browsing system is as follows.

If a user selects facsimile transmission of image data stored in the storage section 28 by a hardware key or software key, when the user terminates the connection to the Internet of the communication network 13, the portable terminal sends the URL (uniform resource locator) of the website 14 and the telephone number of the facsimile 15 to the service center 30.

The service center 30 accesses the website 14, based on the URL received from the portable terminal 11, captures the associated image data and converts the image data to facsimile communication data. Next, the service center 30 sends the converted facsimile communication data from the image data to the facsimile 15, based on the telephone number of the facsimile 15 send from the portable terminal 11. The facsimile 15, in the same manner as would a conventional facsimile, outputs the facsimile communication data by printing it onto printing paper, or by displaying it on a display of the facsimile 15.

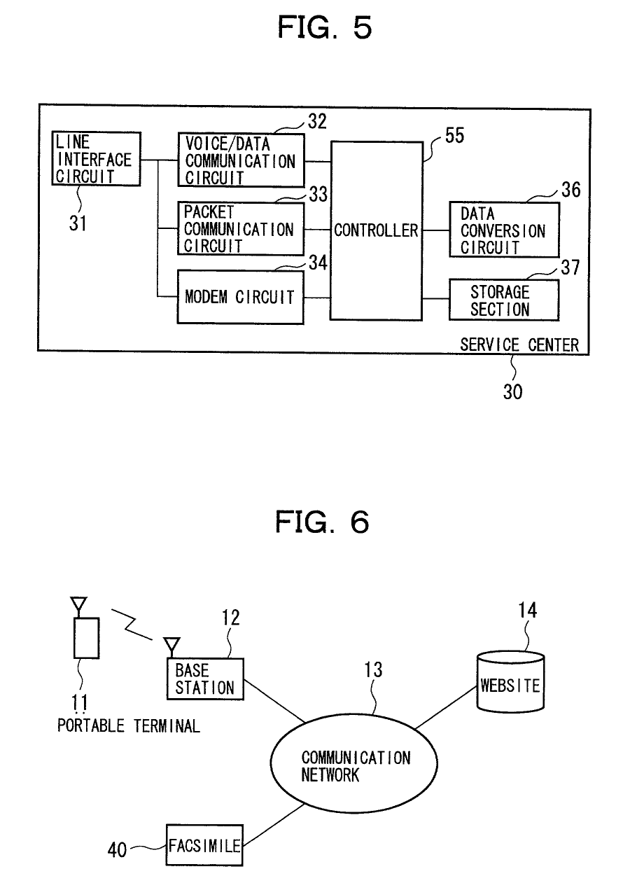

FIG. 5 shows a block diagram of the configuration of the service center 30, which is made up of a line interface circuit 31, a voice/data communication circuit 32, a packet communication circuit 33, a modem circuit 34, a data conversion circuit 36, a storage section 37, and a controller 35.

The line interface circuit 31 is provided to make connection to the communication network 13. The voice/data communication circuit 32 connects to the communication network 13 and performs communication of voice and data. The packet communication circuit 33 connects to the communication network 13 and performs packet communication. The modem circuit 34 connects to the communication network 13 and performs facsimile communication. The data conversion circuit 36 converts website data and the like to facsimile communication data. The storage section 37 stores image data of a website. The controller, which includes a CPU or the like, performs control of the line interface circuit 31, the voice/data communication circuit 32, the packet communication circuit 33, the modem circuit 34, the data conversion circuit 36, and the storage section 37.

Upon receiving the telephone number of the facsimile 15 and the URL of the website 14, the controller 35 performs control of the line interface circuit 31, and the voice/data communication circuit 32 or packet communication circuit 35, and stores data sent from the portable terminal 11 into the storage section 37. Next, the controller 35, in accordance with the URL of the website 14 received from the portable terminal 11, controls the voice/data communication circuit 32 or the packet communication circuit 33 so as to access the website 14 via the communication network 13, captures the image data of the website 14, and temporarily stores same in the storage section 37.

Next, the controller 35 reads in image data of the website 14 from the storage section 37, and sends the data to the data conversion circuit 36, which converts the image data of the website 14 to facsimile communication data and sends the converted data to the controller 35, whereupon the controller 35 temporarily stores the received converted facsimile communication data into the storage section 37. The controller 35 next reads from the storage section 37 the telephone number of the facsimile 15 received from the portable terminal 11, and performs control of the modem circuit 34 and the line interface circuit 31 so as to call the facsimile 15. When communication is established between the service center 30 and the facsimile 15, the controller 35 reads from the storage section 37 the image data of the website 14 that had been converted to facsimile communication data and controls the modem circuit 34 and the line interface circuit 31 so as to sent this converted data to the facsimile 15, and also gives notification of the result of this transmission to the portable terminal 11.

In terms of methods for causing the telephone number of the facsimile 15 to be sent to the service center 30, methods that can be envisioned are a method, as noted above, in which the user registers the telephone number beforehand, and a method in which, after completion of the connection to the communication network 13, the user operates the operating section 27 so as to input the telephone number of the facsimile 15.

In the fourth embodiment of a website browsing system according to the present invention, rather than waiting for the completion of the connection to the communication network 13, as is the case with the third embodiment, the image data of the website 14 is sent to the facsimile 15 in real-time, with the portable terminal 11 remaining connected to the communication network 13. The operation of this embodiment is as follows.

First, the user accesses the website 14 by packet communication, using the portable terminal 11. When this is done, if the user selects “Facsimile Transmission” from a hardware key or a software menu or the like, the portable terminal 11 connects by packet communication to the service center 30, and send thereto the telephone number of the facsimile 15 and the URL of the website 14.

The service center 30 accesses the website 14 using the URL received from the portable terminal 11, and captures the image data therefrom, whereupon it converts this captured image data to facsimile communication data. Next, the service center 30 calls the facsimile 15, using the telephone number of the facsimile 15 as received from the portable terminal 11, and sends the facsimile communication data to the facsimile 15. The facsimile 15, in the same manner as would a conventional facsimile, outputs the facsimile communication data by printing it onto printing paper, or by displaying it on a display of the facsimile 15.

The service center 30 can be established within the system of the portable terminal (PDC) provider and operated automatically, and can alternatively be installed at the website, so as to make connection to the facsimile 15 in accordance with a telephone number of the facsimile 15 input from the portable terminal 11.

The fifth embodiment of a website browsing system according to the present invention is shown in the block diagram of FIG. 6. As shown in FIG. 6, this embodiment is the first embodiment with the facsimile 15 replaced by the facsimile 40. The facsimile 40 accesses the website 14 based on the URL received from the portable terminal 11. The operation of this website browsing system is as follows.

In this website browsing system, the user first accesses the website 14 using the portable terminal 11. At this point, if the user selects “Facsimile Transmission” from a hardware key or software menu, after completion of the connection to the communication network 13, the URL of the website 14 is sent to the facsimile 40 via the telephone line. The facsimile 40, based on the URL received from the portable terminal 11, accesses the website 14 and captures the associated image data, converts the image data to facsimile communication data and either prints it or displays it on the display of the facsimile 40.

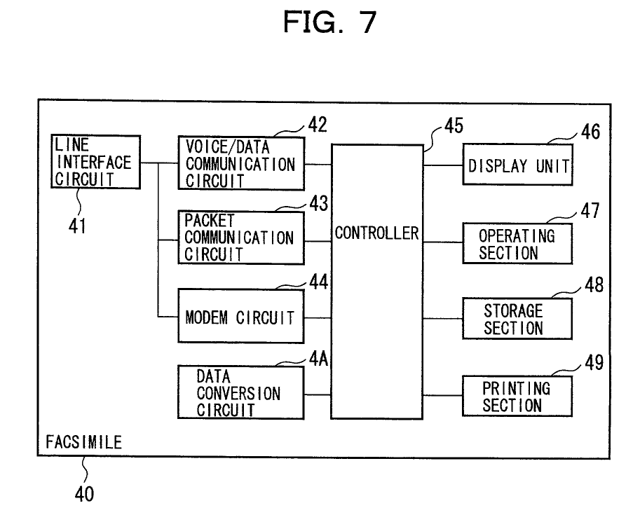

FIG. 7 is a block diagram showing the configuration of the facsimile 40. The facsimile 40 is made up of a line interface circuit 41, a voice/data communication circuit 42, a packet communication circuit 43, a modem circuit 44, a display unit 46, an operating section 47, a storage section 48, printing section 49, and a controller 45.

The line interface circuit 41 connects to the communication network 13. The voice/data communication circuit 42 connects to the communication network 13 via the line interface circuit 41, and performs communication of voice and data. The packet communication circuit 43 connects to the communication network 13 and performs packet communication. The modem circuit 44 connects to the communication network 13 and perform facsimile communication. The display unit 46 displays a clock that indicates time and a telephone number or the like. The operating section 47 is an interface between the user and the facsimile 40, and has menu keys, and dialing keys and the like. The storage section 48 stores a telephone number and image data such as that of the website 14. The printing section 49 prints image data on paper. A data conversion circuits 4A converts website image data to facsimile communication data. The controller 45, which includes a CPU or the like, performs control of the line interface circuit 41, the voice/data communication circuit 42, the packet communication circuit 43, the modem circuit 44, the display unit 46, the storage section 48, the printing section 49, and the data conversion circuit 4A. The operation of the website browsing system configured in this manner is as follows.

When communication is established between the portable terminal 11 and the facsimile 40, the controller 25 reads the URL of the website 14 from the storage section 48, and the URL of the website 14 is sent to the facsimile 40. Within the facsimile 40, the controller 45 controls the line interface circuit 41 and the voice/data communication circuit 42 so as to store into the storage section 48 the URL of the website 14 that was sent from the portable terminal 11. Next, the controller 45, in accordance with the URL of the website 14 received from the portable terminal 11, controls the line interface circuit and the voice/data communication circuit 42 or packet communication circuit 43 so as to connect to the communication network 13 and access the website 14, capture the image data of the website 14, and temporarily store the image data in the storage section 48.

Next, the controller 45 reads the data of the website 14 from the storage section 48, and sends the data to the data conversion circuit 4A, which converts the website 14 data to facsimile communication data and sends the converted data to the controller 45.

Upon receiving the converted facsimile communication data, the controller 45 sends the facsimile communication data to the printing section 49, which prints it on paper. When printing, it is further possible to first temporarily store the facsimile communication data in the storage section 48, in which case rather than printing immediately, the printing is done in response to a user operation.

A further method that can be envisioned is one whereby the image data of the website 14 is printed without converting it at the data conversion circuit 4A. As methods of selecting the telephone number of the facsimile 40, it is possible imagine, as noted earlier, a method whereby the user registers a telephone number beforehand, and a method whereby the telephone number of the facsimile 40 is input by the user operating the operating section 27 after completion of the connection with communication network 13.

The method of resolving the URL of the facsimile 40 is as follows.

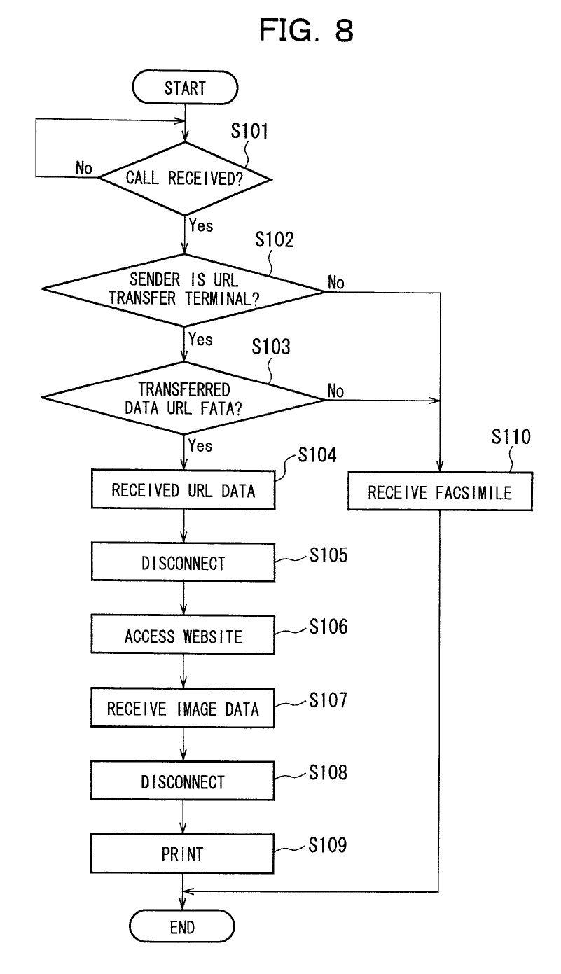

Assume in this case that the facsimile 40 has previously registered therewithin the telephone number of the portable terminal that transfers the URL. FIG. 8 is a flowchart showing the operation of the facsimile 40 for the case of receiving a call in this embodiment of the present invention. When the facsimile 40 receives a call from its waiting mode (step S101) it makes judgment, based on the telephone number of the caller, whether or not the caller is a portable terminal that has been registered as a URL transfer terminal (step S102). In the case in which a call is received from a telephone that does not give send its caller ID, or from a conventional fixed telephone or unregistered portable terminal, facsimile reception is done using the conventional facsimile communication protocol (step S110), at which point the processing ends.

At step S102, if the judgment is made that the calling party is a portable terminal 11 that had been registered as a URL transfer portable terminal 11, the facsimile 40 makes a judgment from the synchronizing signal as to whether the data is URL transfer data or facsimile communication data (step S103). If the result of the judgment is that facsimile communication data is being received, facsimile receiving operation is performed in accordance with a facsimile communication protocol (step S110), after which processing is ended.

If, however, the judgment at step S103 that URL transfer data is being received, the facsimile 40 receives and reads the URL transfer data (step S104), stores this URL in the storage section 48, and disconnects from the portable terminal 11 (step S105).

Next, the facsimile 40 accesses the website 14 at the URL received from the portable terminal 11 (step S106), and receives the image data therefrom (step S107). When the facsimile 40 completes reception of image data from the website 14, it disconnects the communication (step S108), and performs a printing operation (S109), which ends the processing.

The sixth embodiment of a website browsing system according to the present invention is formed by replacing the URL transfer method used in the fourth embodiment by the use of electronic mail to transfer the URL of a website to the facsimile 40. The operation of a website browsing system according to the sixth embodiment is as follows.

First, the user uses the portable terminal 11, which is connectable to the communication network 13, to access a website 14. If the user selects “Facsimile Transmission” from a hardware key or software menu or the like, the portable terminal 11, after completing the connection with the communication network 13, sends electronic mail with the URL of the website 14 as the subject to the facsimile 40.

Upon receiving the electronic mail from the portable terminal 11, the facsimile 40 accesses the website 14 at the URL indicated by the subject of the electronic mail, captures the image data thereof, converts the image data to facsimile communication data, and prints the data on paper or displays the data on the display of the facsimile 40.

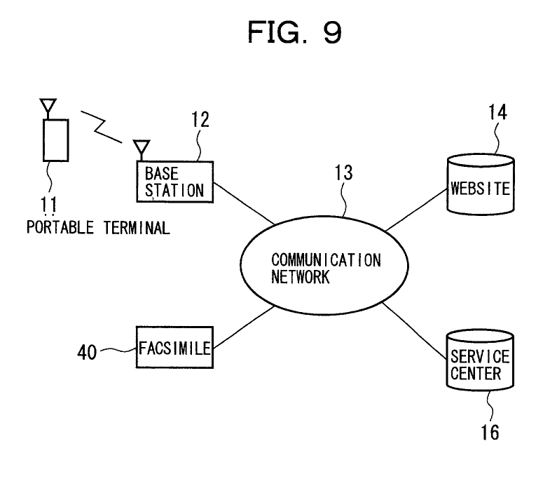

The configuration of the seventh embodiment of a website browsing system according to the present invention is shown in the block diagram of FIG. 9. This website browsing system is different from the sixth embodiment in that the destination of the electronic mail sent from the portable terminal 11 is not the facsimile 40, but rather the service center 16. The operation of the seventh embodiment is as follows.

The user first uses the portable terminal 11, which is connectable to the communication network 13, to access a website 14.

If the user selects “Facsimile Transmission” from a hardware key or a software menu, after completion of the connection to the communication network 13, the portable terminal 11 sends electronic mail with the URL of the website 14 as the subject and the telephone number of the facsimile 40 as the body to the service center 16.

The service center 16 accesses the website 14 at the URL indicated by the subject of the electronic mail from the portable terminal 11, captures the image data thereof, and converts the image data to facsimile communication data. Next, based on the telephone number of the facsimile 40 contained as the body of the electronic mail, the service center 16 sends the image data of the website 14, which had been converted to facsimile communication data, to the facsimile 40. The facsimile 40, in the same manner as would a conventional facsimile, outputs the facsimile communication data by printing it onto printing paper, or by displaying it on a display of the facsimile 40.

By adopting the technical constitution described above in detail, the present invention achieves two major effects.

(1) It enables viewing of a website with a portable terminal having a small display capacity.

(2) It enables the receiving of printing service, using a facsimile having a printing function, even from a portable terminal not having a printing function itself.

What is claimed is:

1. A website browsing system, comprising:
a communication network;
a wireless base station connected to said communication network;
a website, making available image data via said communication network;
a facsimile connectable via a telephone line; and
a portable terminal, connectable to said communication network via said base station, and which, after completion of a connection operation with respect to said communication network in response to a user instruction, converts said image data made available from said website to data for facsimile communication, and sends said facsimile communication data via the telephone line to said facsimile.

2. A website browsing system, comprising:
a communication network;
a wireless base station connected to said communication network;
a website, making available image data via said communication network;
a facsimile connectable via a telephone line;
a service center, connectable to said communication network, which sends received facsimile communication data to said facsimile via the telephone line; and
a portable terminal, connectable to said communication network via said base station, which, during connection to said communication network, in accordance with an instruction from a user, converts said image data made available from said website to facsimile communication data, and sends said facsimile communication data via said communication network to said service center.

3. A website browsing system, comprising:
a communication network;
a wireless base station connected to said communication network;
a website, making available image data via said communication network;
a facsimile connectable via a telephone line;
a service center, connectable to said communication network, which accesses said website, in accordance with a received URL of said received website, converts image data made available from said website to facsimile communication data, and sends said facsimile communication data to a received telephone number of said facsimile in accordance with the received telephone number of said facsimile; and
a portable terminal, connectable to said communication network via said base station, which, after completion of a connection to said communication network, in accordance with an instruction from a user, sends a URL of said website and a telephone number of said facsimile to said service center.

4. A website browsing system, comprising:
a communication network;
a wireless base station connected to said communication network;
a website, making available image data via said communication network;
a facsimile connectable via a telephone line;
a service center, connectable to said communication network, which accesses said website, in accordance with a received URL of said website, converts image data made available from said website to facsimile communication data, and sends said facsimile communication data to a facsimile with a received telephone number of said facsimile; and
a portable terminal, connectable to said communication network via said base station, which, during connection to said communication network, in accordance with an instruction from a user, sends a URL of said website and a telephone number of said facsimile to said service center.

5. A website browsing system, comprising:
a communication network;
a wireless base station connected to said communication network;
a website, making available image data via said communication network;
a facsimile connectable to said communication network and to a telephone line, which in a case in which a priory specified URL of said website is sent from a predetermined URL transfer terminal, in accordance with said URL, accesses said website, receives said image data from said website, converts said image data to facsimile communication data, and outputs said data; and
a portable terminal, connectable to said communication network via said base station, which sends a URL of said website selected by a user to said facsimile via said telephone line.

6. A website browsing system, comprising:
a communication network;
a wireless base station connected to said communication network;
a website, making available image data via said communication network;
a facsimile connectable to said communication network and to a telephone line, which in a case in which a subject of an electronic mail sent thereto is a URL of said website, accesses said website in accordance with said URL, receives said image data from said website, converts said image data to facsimile communication data, and outputs said data; and
a portable terminal, connectable to said communication network via said base station, which sends a URL of said website selected by a user as a subject of an electronic mail to said facsimile.

7. A website browsing system, comprising:
a communication network;
a wireless base station connected to said communication network;
a website, making available image data via said communication network;
a facsimile connectable to said communication network;
a service center connectable to said communication network, which in a case in which a subject of a sent electronic mail is the URL of said website, accesses said website in accordance with said URL, receives image data from said website, converts said image data to facsimile communication data, and sends said facsimile communication data to said facsimile; and
a portable terminal, connectable to said communication network via said base station, which sends a URL of said website selected by a user as a subject of an electronic mail to said service center.

8. A portable terminal connectable via a base station to a communication network, which can convert image data made available from said website on said communication network to facsimile communication data.

9. A network server serving as a service center and being connectable to a communication network, which accesses a website on said communication network in accordance with a URL of said website, converts image data made available by said website to facsimile communication data, and sends said facsimile communication data to a facsimile via a telephone line.

10. A facsimile connectable to a communication network and to a telephone line, which in a case in which a URL of a website is sent from a pre-specified URL transfer terminal, accesses said website in accordance with said URL, receives image data from said website, and converts said image data to facsimile communication data.
